(19) United States
(12) Patent Application Publication
(10) Pub. No.: US 2020/0231186 A1
(43) Pub. Date: Jul. 23, 2020

(54) SYSTEMS AND METHODS FOR CREATING RELATIONSHIPS BETWEEN DELIVERY OBJECTS AND ASSIGNING DELIVERY OBJECT OWNERS

(71) Applicant: United States Postal Service, Washington, DC (US)

(72) Inventors: Stephen M. Dearing, Herndon, VA (US); Rosemarie Bolha, Wilkes-Barre, PA (US)

(21) Appl. No.: 16/746,622

(22) Filed: Jan. 17, 2020

Related U.S. Application Data
(60) Provisional application No. 62/794,472, filed on Jan. 18, 2019.

(51) Int. Cl. B60W 60/00; G06Q 50/32; G06Q 10/08

(52) U.S. Cl. CPC B60W 60/00256; G06Q 50/32; G06Q 10/0833; G06Q 10/0832; G06Q 10/08355

(57) ABSTRACT

A system and method for the creation of relationships between delivery objects and vehicles. In some embodiments, the relationships can designate that one delivery object is contained within another delivery object and that an item deliverer is responsible for a particular delivery object.

### INCORPORATION BY REFERENCE OF RELATED APPLICATIONS

Any and all applications for which a foreign or domestic priority claim is identified in the Application Data Sheet as filed with the present application are hereby incorporated by reference under 37 C.F.R. § 1.57. The present application claims priority benefit to U.S. provisional Application No. 62/794,472, filed Jan. 18, 2019, which is incorporated by reference herein in its entirety for all purposes.

### BACKGROUND

### Field

The development relates to a mobile device for creating relationships between items for delivery, things for assisting in the delivery or other things to assist in the delivery of items (collectively “delivery objects”). In some embodiments, items can be envelopes, packages, parcels, suitcases, or other objects that can be delivered. In some embodiments, things that assist in the delivery of items can be containers for items, or vehicles for delivering items, or vehicle trailers for delivering items. In some embodiments, the system can also create relationships between users of the system, typically item delivers, and delivery objects. In some embodiments, the created relationship can designate that an item is contained in another item or in a thing for assisting in the delivery of items. In some embodiments, the relationship can also designate that a user of a system is the “owner,” or is in possession of a particular item or a thing for assisting the delivery of items.

### Description of the Related Art

Item deliverers typically desire to know the precise location of any item they are delivering. In some cases, a part of knowing the location of an item is knowing what container or other object that the item is currently contained in. In some cases, it is also very valuable to know who has the item or item container or other object in their possession or who is responsible for the item, item container, or other object. Thus, a system for creating delivery object associations is greatly desired.

### SUMMARY

In some embodiments, the developments relate to a mobile computing device comprising a scanning module configured to scan a plurality of delivery objects and generate unique identifiers for each delivery object based on the scan; and an association module configured to generate an association between at least a first and second unique identifier from the plurality of the unique identifiers, wherein the association designates that the delivery object associated with the second unique identifier is contained in the delivery object associated with the first unique identifier.

In some embodiments, the delivery objects are items, item containers, vehicles, or vehicle trailers. In some embodiments, the first unique identifier is associated with an item container and the second unique identifier is associated with an item. In some embodiments, the first unique identifier is associated with a vehicle or vehicle trailer and the second unique identifier is associated with an item container.

In some embodiments, the association module is further configured to generate an association between a first, second, and third unique identifier from the plurality of the unique identifiers, wherein the association designates that the delivery objects associated with the second and third unique identifiers are contained in the delivery object associated with the first unique identifier.

In some embodiments, the mobile computing device can further comprise a user interface configured to receive a unique identifier associated with the user of the mobile device; and an ownership module configured to generate an ownership relationship between the unique identifier associated with the user and a unique identifier associated with a delivery object.

In some embodiments, the developments relate to a system for tracking delivery items, the system comprising a first delivery object having a first unique identifier thereon; a second delivery object having a second unique identifier thereon; a delivery vehicle having a third unique identifier thereon; a scanner configured to scan the first unique identifier on the first delivery object and the second unique identifier on the second delivery object; an association module configured to generate an association between the first unique identifier on the first delivery object and the second unique identifier on the second delivery object and the third unique identifier on the delivery vehicle, wherein the association indicates that the first delivery object is contained in the second delivery object and that the second delivery object is on the delivery vehicle; a memory configured to store the association between the first and second unique identifiers; and a tracking module configured to determine the location of the first delivery object based on the location of the delivery vehicle and the association between the first unique identifier and the second identifier, and between the second unique identifier and the third unique identifier.

In some embodiment the delivery objects are items, or item containers and the delivery vehicle comprises a vehicle trailer.

In some embodiments, the first unique identifier is associated with an item and the second unique identifier is associated with an item container.

In some embodiments, the system can further comprise a fourth item having a fourth unique identifier thereon, wherein the scanner is configured to scan the fourth unique identifier, and wherein the association module is configured to store an association between the fourth unique identifier and the second unique identifier, wherein the association indicates that the fourth delivery object is contained in the second delivery object.

In some embodiments, the scanning module is further configured to scan the second unique identifier and to generate a list of unique identifiers associated with the second unique identifier. In some embodiment, the list of unique identifiers associated with the second unique identifier includes the first and fourth unique identifiers.

In some embodiments, the system can further comprise a user interface configured to receive a unique identifier associated with the user of the mobile device, wherein the association module is further configured to generate an ownership relationship between the unique identifier associated with the user and the second unique identifier associated with the second delivery object.

In some embodiments, the system can further comprise a user interface configured to receive a delivery object type for the first and second delivery objects.

In some embodiments, the type of delivery object is one of a container type delivery object or an item type delivery object.

In some embodiments, the development relates to a method for tracking delivery items, the method comprising scanning a first unique identifier on a first delivery object and a second unique identifier on a second delivery object; generating an association between the first unique identifier on the first delivery object and the second unique identifier on the second delivery object and a third unique identifier on a delivery vehicle, wherein the association indicates that the first delivery object is contained in the second delivery object and that the second delivery object is on the delivery vehicle; storing the association between the first and second unique identifiers; and determining the location of the first delivery object based on the location of the delivery vehicle and the association between the first unique identifier and the second identifier, and between the second unique identifier and the third unique identifier.

In some embodiments, the delivery objects are items, or item containers and the delivery vehicle comprises a vehicle trailer.

In some embodiments, the first unique identifier is associated with an item and the second unique identifier is associated with an item container.

In some embodiments, the method further comprises scanning a fourth unique identifier on a fourth delivery object and storing an association between the fourth unique identifier and the second unique identifier, wherein the association indicates that the fourth delivery object is contained in the second delivery object.

In some embodiments, the method can further comprise scanning the second unique identifier and generating a list of unique identifiers associated with the second unique identifier. In some embodiments, the list of unique identifiers associated with the second unique identifier includes the first and fourth unique identifiers.

In some embodiments, the method further comprises receiving a unique identifier associated with the user of the mobile device and generating an ownership relationship between the unique identifier associated with the user and the second unique identifier associated with the second delivery object.

In some embodiments, the method further comprises receiving a delivery object type for the first and second delivery objects. In some embodiments, the type of delivery object is one of a container type delivery object or an item type delivery object.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with the additional specificity and detail through use of the accompanying drawings.

FIG. 1 is a block diagram displaying one embodiment of a mobile device for using the universal application for tracking delivery object associations.

FIG. 2 is block diagram displaying one embodiment of a system for using the universal application for tracking delivery object associations.

FIG. 3 is a flow chart depicting one embodiment of a process for creating delivery object associations.

FIG. 4 is a flow chart depicting one embodiment of a process for assigning ownership of delivery objects and delivery object associations.

FIGS. 5a-e show one embodiment of an application for a mobile device that can create delivery object associations and assigning ownership of delivery objects.

### DETAILED DESCRIPTION

Some embodiments of a system and method for the creation of relationships between delivery objects and item delivers are described herein. In some embodiments, the relationships can designate that one delivery object is contained within another delivery object and that an item deliverer is responsible for a particular delivery object.

The features, aspects, and advantages of the present development will now be described with reference to the drawings of several embodiments which are intended to be within the scope of the embodiments herein disclosed. These and other embodiments will become readily apparent to those skilled in the art from the following detailed description of the embodiments having reference to the attached figures, the development not being limited to any particular embodiment(s) herein disclosed.

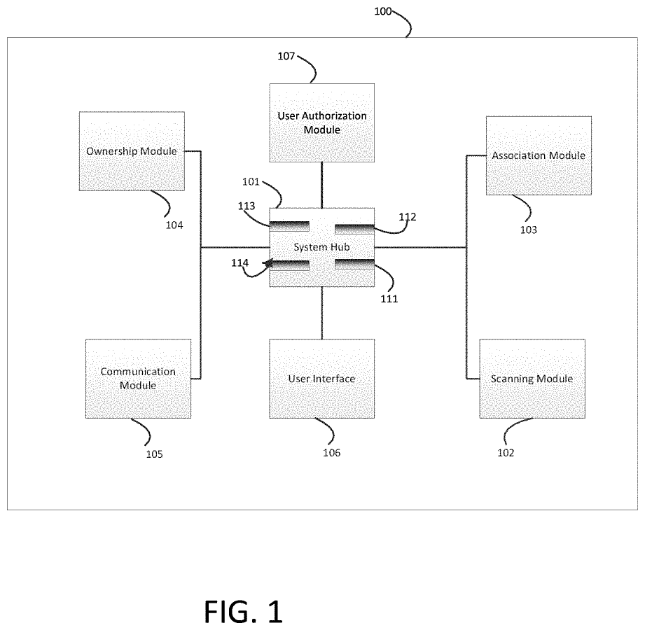

The system and method described herein relate to generating and communicating delivery object associations and ownership data. FIG. 1 depicts an embodiment of mobile device 100 for using the universal application. The mobile device 100 comprises a system hub 101, scanning module 102, association module 103, ownership module 104, communication module 105, and user interface 106 and user authorization module 107. The system hub 101 is in communication, either wired or wirelessly, with at least the scanning module 102, association API 103, ownership API 104, communication module 105, and user interface 106.

The system hub 101 may comprise or be a component of a processing system implemented with one or more processors. The system hub 101 may be a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The system hub 101 may comprise a processor 111 such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series or FX® processor, or the like. The processor 111 typically has conventional address lines, conventional data lines, and one or more conventional control lines. The processor 111 may be in communication with a processor memory 112, which may include, for example, RAM memory, flash memory, ROM memory, EPROM memory, EEPROM memory, registers, hard disk, a removable disk, a CD-ROM, or any other form of storage medium known in the art. The processor memory 112 may include, for example, software, at least one software module, instructions, steps of an algorithm, or any other information. In some embodiments, the processor 111 performs processes in accordance with instructions stored in the processor memory 112. These processes may include, for example, controlling features and/or components of the mobile device 100, and controlling access to and from, and transmitting information and data to and from the system hub 101 and the constituent components of the mobile device 100, as will be described herein.

The system hub 101 comprises a system memory 113 configured to store information, such as delivery object assignments, ownership information and the like. The system memory 113 may comprise a database, a comma delimited file, a text file, or the like. The system hub 101 is configured to coordinate and direct the activities of the components of the mobile device 100, and to coordinate generating delivery object associations and delivery object ownership data.

In some embodiments, the processor 111 is connected to a communication feature 114. The communication feature 114 is configured for wired and/or wireless communication. In some embodiments, the communication feature 114 communicates via telephone, cable, fiber-optic, or any other wired communication network. In some embodiments, the communication feature 114 may communicate via cellular networks, WLAN networks, or any other wireless network. The communication feature 114 is configured to receive instructions and to transmit and receive information among components of the mobile device 100, and, in some embodiments, with a central server or other resource outside the mobile device 100, as desired.

In some embodiments, the system hub 101 is in communication with scanning module 102. In some embodiments, the scanning module 102 may comprise a processor, memory, databases, address and control lines, and other components similar to those described herein for the system hub 101. In other embodiments, the scanning module 102 may be configured to use the processor, memory, databases, address and control lines, and other components of system hub 101, or a combination of its own components and the system hub 101's components.

In some embodiments, scanning module 102 can be used to scan things that will be delivery objects. In some embodiments, scanning module 102 can be a camera, a QR code scanner, or barcode scanner or the like. In some embodiments, the scanning module 102 can be used to scan a barcode, QR code or other computer readable code. In some embodiments, the scanning module 102 can scan the barcode, QR code, or other computer readable code, and identify a unique identifier communicated by the computer readable code that identifies a delivery object. In some embodiments, the mobile device has additional information about the delivery object stored in memory and associated with the unique identifier.

In some embodiments, the system hub 101 is in communication with association module 103. In some embodiments, the association module 103 may comprise a processor, memory, databases, address and control lines, and other components similar to those described herein for the system hub 101. In other embodiments, the association module 103 may be configured to use the processor, memory, databases, address and control lines, and other components of system hub 101, or a combination of its own components and the system hub 101's components.

In some embodiments, association module 103 can be used to create an association between two delivery objects. In some embodiments, this association can designate the relationship between the two delivery objects. For example, the association can designate that one delivery object is contained within another delivery object. In some embodiments, the association module 103 can create an association between two delivery objects scanned by the scanning module 102. For example, the association module 102 can create an association that shows that a scanned item to be delivered is contained within a scanned container. Similarly, the association module 102 can create an association designating that a scanned container is contained within a scanned vehicle or vehicle trailer.

In some embodiments, system hub 101 is in communication with ownership module 104. In some embodiments, the ownership module 104 may comprise a processor, memory, databases, address and control lines, and other components similar to those described herein for the system hub 101. In other embodiments, the ownership module 104 may be configured to use the processor, memory, databases, address and control lines, and other components of system hub 101, or a combination of its own components and the system hub 101's components.

In some embodiments, ownership module 104 can create an ownership relationship between an item deliverer and a delivery object. In some embodiments, an ownership relationship can designate that a particular item deliverer is responsible for a particular delivery object or that the particular item deliverer has the delivery object in his or her possession. In some embodiments, the item deliverer can be identified by a unique code or user ID that is entered into the mobile device via user interface 106. In some embodiments, the item deliverer can instead be identified by using scanning module 102 to scan a barcode, QR code, or other computer readable code, and receive a unique identifier back. In some embodiments, the barcode, QR code, or other computer readable code can be placed on an employee badge or other physical employee identifier. In some embodiments, ownership module 102 can create an ownership relationship between an item deliverer and delivery objects.

In some embodiments, system hub 101 is in communication with communication module 105. In some embodiments, the communication module 105 may comprise a processor, memory, databases, address and control lines, and other components similar to those described herein for the system hub 101. In other embodiments, the communication module 105 may be configured to use the processor, memory, databases, address and control lines, and other components of system hub 101, or a combination of its own components and the system hub 101's components.

In some embodiments, communication module 105 is responsible for communications between the mobile device 100 and other devices via wired and/or wireless communication. In some embodiments, the communication module 105 communicates via telephone, cable, fiber-optic, or any other wired communication network. In some embodiments, the communication module 105 may communicate via cellular networks, WLAN networks, or any other wireless network. In some embodiments, the communication module 106 can be used to communicate the relationships between delivery objects that are created by the association module 103 and ownership module 104. In some embodiments, the communication module 105 can transmit the relationships to a central database, where the information from multiple mobile device 100 can be stored.

In some embodiments, system hub 101 is in communication with user interface 106. In some embodiments, the user interface 106 may comprise a processor, memory, databases, address and control lines, and other components similar to those described herein for the system hub 101. In other embodiments, the user interface 106 may be configured to use the processor, memory, databases, address and control lines, and other components of system hub 101, or a combination of its own components and the system hub 101's components.

In some embodiments, the user interface 106 can be used by the operator of mobile device 100 to control its various functions. In some embodiments, the user interface can comprise virtual buttons that are manipulated via a touch screen, mouse, keyboard, or other input device. In some embodiments, the user interface 106 can be used by the user to manually enter a unique identifier for a delivery object instead of scanning a delivery object.

In some embodiments, system hub 101 is in communication with user authorization module 107. In some embodiments, the user authorization module 107 may comprise a processor, memory, databases, address and control lines, and other components similar to those described herein for the system hub 101. In other embodiments, the user authorization module 107 may be configured to use the processor, memory, databases, address and control lines, and other components of system hub 101, or a combination of its own components and the system hub 101's components.

In some embodiments, user authorization module 107 is responsible for ensuring that a user is authorized to use the mobile device 100. In some embodiments, user authorization module 107 can confirm that a user is authorized by receiving a unique identifier from a user such as a user name and password, or by scanning an employee badge displaying a computer readable code. The user authorization module 107 can then send this unique identifier to a central server, which confirms that the user is authorized to use the system,

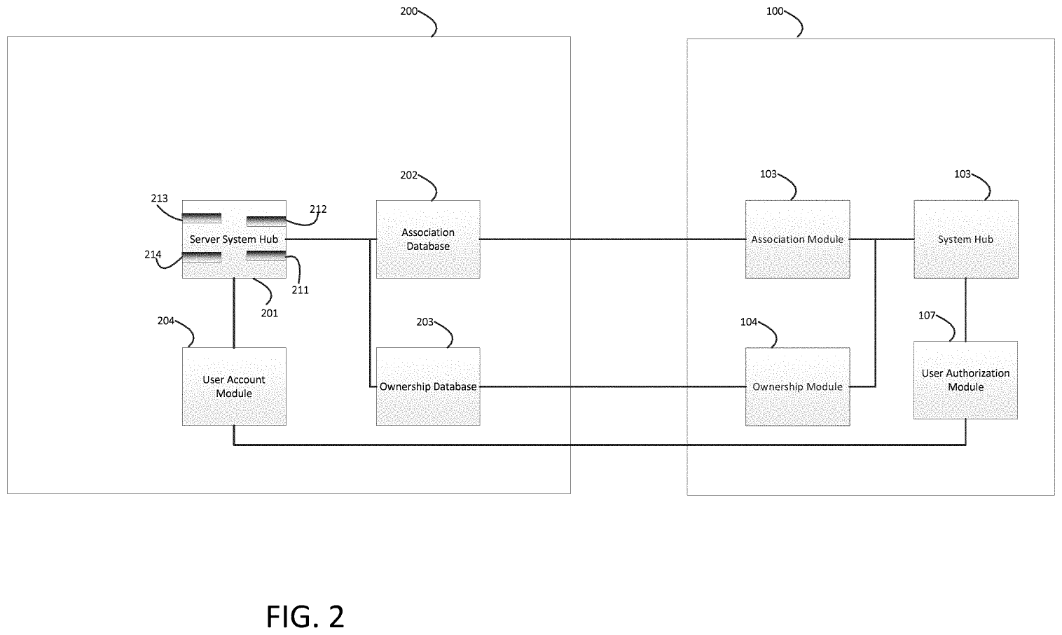

FIG. 2 is block diagram displaying one embodiment of a system for using the universal application for tracking delivery object associations. In some embodiments, a central server 200 can be in communication with multiple mobile devices 100. In some embodiments, central server 200 can receive item relationship information such as item associations and item ownership information from multiple mobile devices 100. This information can then be accessed by other systems that need information on delivery objects, and who or what is designated as the owner of a delivery object. In some embodiments, central server 200 can comprise a server system hub 201 in communication with an association database 202, an ownership database 203, and a user account module 204. In some embodiments, the central server 200 can be a United States Postal Service Business Customer Gateway.

The server system hub 201 may comprise or be a component of a processing system implemented with one or more processors. The server system hub 201 may be a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The server system hub 201 may comprise a processor 211 such as, for example, a microprocessor, such as a Pentium® processor, a Pentium® Pro processor, a 8051 processor, a MIPS® processor, a PowerPC® processor, an Alpha® processor, a microcontroller, an Intel CORE i7®, i5®, or i3® processor, an AMD Phenom®, A-series, or FX® processor, or the like. The processor 211 typically has conventional address lines, conventional data lines, and one or more conventional control lines. The processor 211 may be in communication with a processor memory 212, which may include, for example, RAM memory, flash memory, ROM memory, EPROM memory, EEPROM memory, registers, hard disk, a removable disk, a CD-ROM, or any other form of storage medium known in the art. The processor memory 212 may include, for example, software, at least one software module, instructions, steps of an algorithm, or any other information. In some embodiments, the processor 211 performs processes in accordance with instructions stored in the processor memory 212. These processes may include, for example, controlling features and/or components of the expected delivery window generation system 100, and controlling access to and from, and transmitting information and data to and from the server system hub 201 and the constituent components of the mobile device 100, as will be described herein.

The server system hub 201 comprises a system memory 213, configured to store information, such delivery object associations and ownership data and the like. The system memory 213 may comprise a database, a comma delimited file, a text file, or the like. The server system hub 201 is configured to coordinate and direct the activities of the components of the central server 200.

In some embodiments, the processor 211 is connected to a communication feature 214. The communication feature 214 is configured for wired and/or wireless communication. In some embodiments, the communication feature 214 communicates via telephone, cable, fiber-optic, or any other wired communication network. In some embodiments, the communication feature 214 may communicate via cellular networks, WLAN networks, or any other wireless network. The communication feature 214 is configured to receive instructions and to transmit and receive information among components of the mobile device 100, and in some embodiments, with a separate central server (not shown) or other resource outside the mobile device 100, as desired.

In some embodiments, system hub 201 is in communication with an association database 202. In some embodiments, the association database 202 may comprise a processor, memory, databases, address and control lines, and other components similar to those described herein for the system hub 201. In other embodiments, the association database 202 may be configured to use the processor, memory, databases, address and control lines, and other components of system hub 201, or a combination of its own components and the system hub 201's components.

The association database 202 can contain information concerning the association relationships between delivery objects. In some embodiments, the association database can contain information on all of the association relationships created by any number of mobile devices 100. In some embodiments, the mobile devices 100 can transmit the information from the association module 103 to association database 202 through communication module 105. In some embodiments, a similar server side communication module (not shown) is available to assist in the transfer of information from association module 103 to association database 202. In some embodiments, association database 202 can transmit the association information to other devices or applications.

In some embodiments, the association database 202 contains information about certain delivery objects, such as a particular object's location. In some embodiments, the association can impute this among all the delivery objects associated together. For example, the association database 202 could contain a tracking module (not shown), that contains the location of all delivery trailers in the database. The association database 202 could then determine all of the items contained within the trailer as having the same location as the trailer.

In some embodiments, system hub 201 is in communication with an ownership database 203. In some embodiments, the an ownership database 203 may comprise a processor, memory, databases, address and control lines, and other components similar to those described herein for the system hub 201. In other embodiments, the ownership database 203 may be configured to use the processor, memory, databases, address and control lines, and other components of system hub 201, or a combination of its own components and the system hub 201's components.

The ownership database 203 can contain information concerning the ownership relationship of delivery objects, and the users of mobile devices. In some embodiments, the mobile devices 100 can transmit the information from the ownership module 104 to ownership database 203 through communication module 105. In some embodiments, a similar server side communication module (not shown) is available to assist in the transfer of information from ownership module 104 to ownership database 203. In some embodiments, ownership database 203 can transmit the association information to other devices or applications.

In some embodiments, system hub 201 is in communication with an user account module 204. In some embodiments, the an user account module 204 may comprise a processor, memory, databases, address and control lines, and other components similar to those described herein for the system hub 201. In other embodiments, the user account module 204 may be configured to use the processor, memory, databases, address and control lines, and other components of system hub 201, or a combination of its own components and the system hub 201's components.

The user account module 204 allows a particular user who wishes to use a mobile device 100 to create an account on the system. In some embodiments, user account module 204 can receive a request from a user to create an account. In some embodiments, this request can be sent via a personal computer or mobile computing device or the like. In some embodiments, the central server then creates and stores a unique identifier for the new account, such as a user name or password. In some embodiments, user account module 204 can also allow the user to download an application onto any mobile computing device to allow it to perform the functions of a mobile device 100.

In some embodiments, user account module 204 can also receive unique identifiers from user authorization module 107 and confirm for the mobile device 100 that a particular user has created an account and is authorized to view the system.

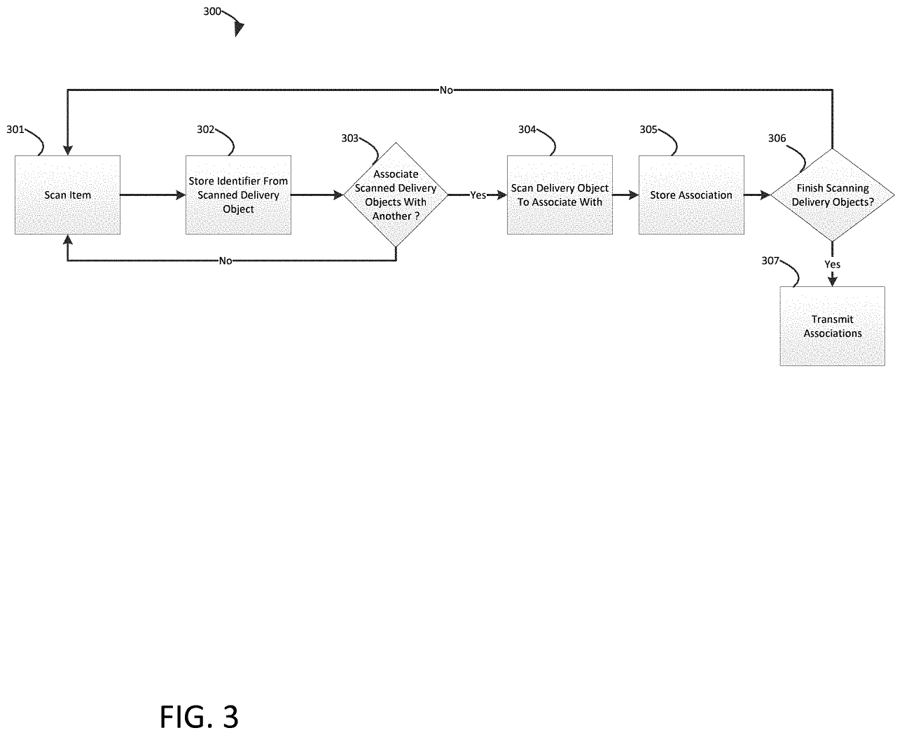

FIG. 3 is a flow chart depicting one embodiment of a process 300 for creating item associations. In some embodiments, the process starts in the process block 301. In process block 301, the mobile device 100 scans a delivery object. In some embodiments, mobile device 100 uses scanning module 102 to scan the delivery object. In some embodiments, the scan allows the mobile device 100 to identify a unique computer readable code that identifies the delivery object. In some embodiments, the user of the mobile device 100 can instead enter in the unique identifier of an object via user interface 106 instead of scanning the object. The process then proceeds to process block 302.

In process block 302, the mobile device stores the unique identifier of the delivery objects in memory. In some embodiments, this can take the form of a list of identifiers for recently scanned items or things for assisting in the delivery of item. In some embodiments, this list can be stored in memory until the entire list of scanned things is associated with another delivery object. Once the association occurs, the list can then be purged from memory, allowing a new list to be created. Once the unique identifier has been stored, the process proceeds to decision block 303.

In decision block 303, the mobile device 100 determines whether the user of the mobile device 100 desired to associate the scanned delivery objects with another delivery object. In some embodiments, the user of the mobile device 100 can use the user interface 106 to select an option to associate the scanned delivery objects with another delivery object. If the user selects the option to associate the scanned delivery objects with another delivery object, the process advances to process block 304, otherwise the process returns to process block 301.

In process block 304, the mobile device 100 scans the delivery object that will be associated with all of the stored identifiers from the previously scanned delivery objects. In some embodiments, the mobile device 100 can use scanning module 102 to scan the delivery objects. Based on the scan, the mobile device 100 determines the unique identifier of the scanned delivery object in the manner previously described. In some embodiments, the user of the mobile device 100 can instead enter in the unique identifier of an object via user interface 106 instead of scanning the object. The process then proceeds to process block 305.

In process block 305, the mobile device 100 creates and stores an association between the previously scanned delivery objects and the delivery object that was scanned to associate those previously scanned delivery objects with. In some embodiments, the mobile device 100 can use the association module 103 to create and store that association. In some embodiments, the association can designate that a set of delivery objects are contained within another delivery object. The process then proceeds to decision block 306. In some embodiments, after the association has been stored, the list of previously scanned delivery objects is wiped from memory, to allow a new list to be created as the process continues.

In decision block 306, the user of mobile device 100 determines if he or she is finished scanning delivery objects. In some embodiments, the user of the mobile device 100 can input his or her decision into the mobile device 100 using user interface 106. If the user is finished, the process proceeds to process block 307. If the user is not finished, the process returns to process block 301.

In process block 307, the mobile device 100 transmits all of the associations created in the process to central server 200. In some embodiments, the mobile device 100 can communicate all of the associations to association database 202 using communication module 106. The process then ends.

It is to be understood by one of ordinary skill in the art that the process 300 is only one possible embodiment of a process of creating associations between delivery objects and that the process could be modified or changed to still reach the same results. In some embodiments, for example, the process can first receive a scan of a delivery object that will contain other delivery objects and subsequent scans will designate the items to be contained. In some embodiments, the process 300 can receive the scan of the delivery object that will contain other objects and the objects to be contained in any order, but the delivery objects can have flags associated with each object to determine which is which.

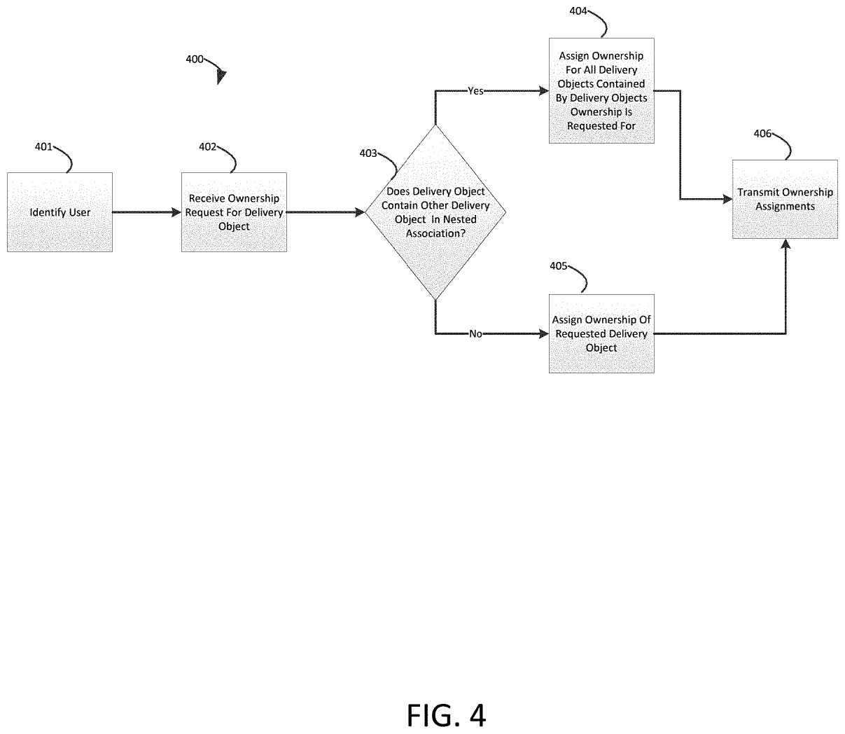

FIG. 4 is a flow chart depicting one embodiment of a process 400 for assigning ownership of items and item associations. The process begins in process block 401. In process block 401, the mobile device 100 identifies the current user of the mobile device 100. In some embodiments, the mobile device 100 identifies the user by having the user input a unique identifier into the mobile device, such as a username and password. In some embodiments, the mobile device 100 identifies the user by using scanning module 102 to scan a barcode, QR code, or other computer readable code that can be placed on an employee badge or other physical employee identifier. The process then proceeds to process block 402.

In process block 402, the mobile device 100 receives an ownership request for a particular delivery object. In some embodiments, the ownership request is generated automatically when a delivery object is scanned, such as when a delivery object is scanned in the process shown in FIG. 3. The ownership request can separately have the user of the mobile device 100 enter an ownership request for a particular object via manually entering a unique identifier for the delivery object via user interface 106. The process then proceeds to decision block 403.

In decision block 403, the mobile device 100 determines if the delivery object that ownership is being requested for is in an association with any other objects and if those associated objects are in an association with any other objects and so forth, all the way down the potential chain of associations. In some embodiments, the mobile device 100 determines these associations by examining any associations stored in association module 103, or by requesting all the relevant associations from association database 202. If there are multiple associations, the process proceeds to process block 404. If there are no associations, the process proceeds to process block 405.

In process block 404, the mobile device 100 assigns the user ownership of all of the nested delivery objects it determined are associated with each other using ownership module 104. The process then proceeds to process block 406.

In process block 405, the mobile device 100 assigns the user ownership of just the delivery object that the mobile device 100 received an ownership request for using ownership module 104. The process then proceeds to process block 406.

In process block 406, the mobile device 100 transmits the ownership assignments to central server 200. In some embodiments, communication module 106 transmits the ownership assignments to ownership database 203. The process then ends.

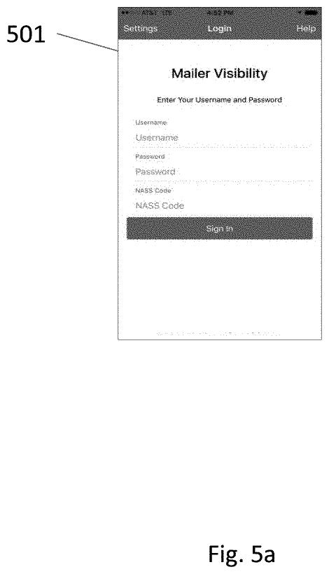

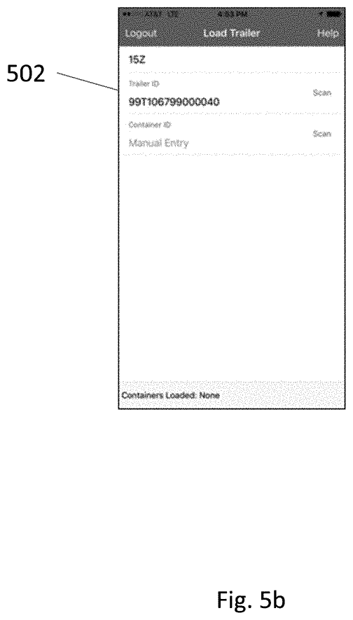

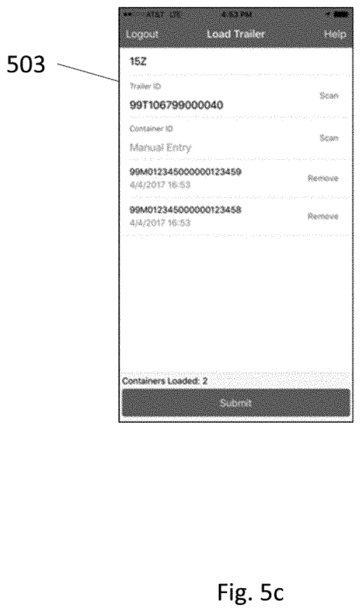

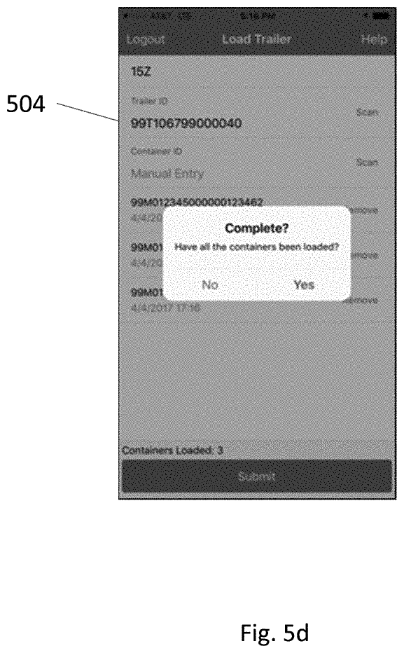

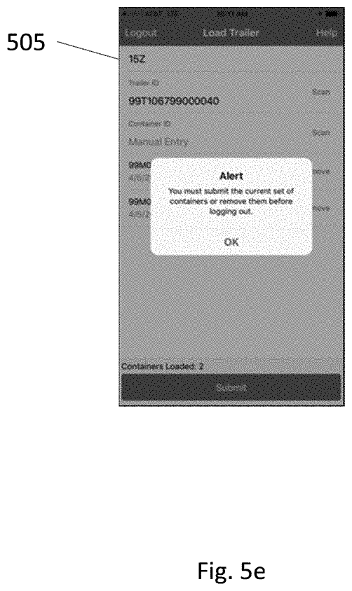

FIGS. 5a-e show one embodiment of an application for a mobile device that can create item associations and assign ownership of items. FIG. 5a displays an application screen 501. In application screen 501, users enter their unique usernames and passwords into the mobile devices 100. Users can also input a particular code that is a unique identifier of the mailing facility that the user is associated with. In some embodiments, the particular code is a NASS code, which is a unique 5 character identifier that distinguishes facilities across postal systems. In some embodiments, the user must have previously registered an account from the central server 200 in order to be able to login using their username and password. Once all of the users information has been entered, users can click on the sign in button.

FIG. 5b displays an application screen 502 that allows a user to scan or enter a trailer identifier or container identifier. In some embodiments, the user can click on the scan button and then use the mobile device 100 to scan a trailer. To manually enter a trailer identifier, the user can click into the trailer ID section and type the value. If the trailer ID is not properly formatted, an error message will display. In the container ID section, the user can click on the Scan button to scan each container to be loaded in the trailer identified by the trailer ID. To manually enter a container ID, the user can click into the container ID section and type the value. If the container ID is not properly formatted, an error message will display. In some embodiments, this screen retains the last scanned Trailer ID. If the user has additional containers to add to that trailer, more containers can be scanned. Otherwise, the user may scan a new trailer and continue. Once the user is finished scanning containers and trailers, the user can hit the submit button. Users also can log out of the application using the log out button, or receive help using the application from the help button. In some embodiments, the application will automatically logout after 30 minutes of inactivity. A five minute warning will pop-up asking the user if they would like to remain logged in. If confirmed, the 30-minute inactivity counter will be reset to zero.

FIG. 5c displays an application screen 503 similar to application screen 502, except that container ID have been entered into the system. In this screen it can be seen that container ID's can be removed from the system via the remove button.

FIG. 5d displays an application screen 504. In some embodiments, application screen 504 is the screen a user receives after hitting the submit button on applications screen 502 or 503. In some embodiments, the mobile device 100 then asks the user to confirm that all of the containers of items have been loaded into the trailer. In some embodiments, once the user confirms, the mobile device 100 will create an association between all of the containers and the trailer they were loaded into and assign ownership of all of the delivery objects to the user. The mobile device 100 will then transmit this information to central server 200. In some embodiments, if the mobile device 100 is currently not connected to central server 200 through wireless communication, all of the information will be stored locally on mobile device 100 until it can connect to central server 200. In some embodiments, a lack of connection to central server 200 can be displayed to the user visually, such as by coloring some portions of the applications screen red.

FIG. 5e displays an application screen 505 that demonstrates an alert that the user could receive if they attempt to logout without removing containers or submitting the scanned information.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and steps described above. Whether such functionality is implemented in hardware or software depends upon the particular application and design constraints imposed on the overall system.

In one or more aspects, the functions described herein may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware. A person of skill in the art will understand that the functions and operations of the electrical, electronic, and computer components described herein can be carried out automatically according to interactions between components without the need for user interaction.

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

What is claimed is:

1. A system for tracking delivery items, the system comprising:
a first delivery object having a first unique identifier thereon;
a second delivery object having a second unique identifier thereon;
a delivery vehicle having a third unique identifier thereon;
a scanner configured to scan the first unique identifier on the first delivery object and the second unique identifier on the second delivery object;
an association module configured to generate an association between the first unique identifier on the first delivery object and the second unique identifier on the second delivery object and the third unique identifier on the delivery vehicle, wherein the association indicates that the first delivery object is contained in the second delivery object and that the second delivery object is on the delivery vehicle;
a memory configured to store the association between the first and second unique identifiers; and
a tracking module configured to determine the location of the first delivery object based on the location of the delivery vehicle and the association between the first unique identifier and the second identifier, and between the second unique identifier and the third unique identifier.

2. The system of claim 1, wherein the delivery objects are items, or item containers.

3. The system of claim 1, wherein the delivery vehicle comprises a vehicle trailer.

4. The system of claim 1, wherein the first unique identifier is associated with an item and the second unique identifier is associated with an item container.

5. The system of claim 1, further comprising a fourth item having a fourth unique identifier thereon, wherein the scanner is configured to scan the fourth unique identifier, and wherein the association module is configured to store an association between the fourth unique identifier and the second unique identifier, wherein the association indicates that the fourth delivery object is contained in the second delivery object.

6. The system of claim 5, where in the scanning module is further configured to scan the second unique identifier and to generate a list of unique identifiers associated with the second unique identifier.

7. The mobile computing device of claim 6, wherein the list of unique identifiers associated with the second unique identifier includes the first and fourth unique identifiers.

8. The system of claim 1, the system further comprising:
a user interface configured to receive a unique identifier associated with the user of the mobile device; and
wherein the association module is further configured to generate an ownership relationship between the unique identifier associated with the user and the second unique identifier associated with the second delivery object.

9. The system of claim 1, the system further comprising a user interface configured to receive a delivery object type for the first and second delivery objects.

10. The system of claim 9, wherein the type of delivery object is one of a container type delivery object or an item type delivery object.

11. A method for tracking delivery items, the method comprising:
scanning a first unique identifier on a first delivery object and a second unique identifier on a second delivery object;
generating an association between the first unique identifier on the first delivery object and the second unique identifier on the second delivery object and a third unique identifier on a delivery vehicle, wherein the association indicates that the first delivery object is contained in the second delivery object and that the second delivery object is on the delivery vehicle;
storing the association between the first and second unique identifiers; and
determining the location of the first delivery object based on the location of the delivery vehicle and the association between the first unique identifier and the second identifier, and between the second unique identifier and the third unique identifier.

12. The method of claim 10, wherein the delivery objects are items, or item containers.

13. The method of claim 10, wherein the delivery vehicle comprises a vehicle trailer.

14. The method of claim 10, wherein the first unique identifier is associated with an item and the second unique identifier is associated with an item container.

15. The method of claim 10, further comprising scanning a fourth unique identifier on a fourth delivery object and storing an association between the fourth unique identifier and the second unique identifier, wherein the association indicates that the fourth delivery object is contained in the second delivery object.

16. The method of claim 15, further comprising scanning the second unique identifier and generating a list of unique identifiers associated with the second unique identifier.

17. The mobile computing device of claim 16, wherein the list of unique identifiers associated with the second unique identifier includes the first and fourth unique identifiers.

18. The method of claim 10, the method further comprising:
receiving a unique identifier associated with the user of the mobile device; and
generating an ownership relationship between the unique identifier associated with the user and the second unique identifier associated with the second delivery object.

19. The method of claim 10, the method further comprising receiving a delivery object type for the first and second delivery objects.

20. The method of claim 19, wherein the type of delivery object is one of a container type delivery object or an item type delivery object.
